(19) United States
(12) Patent Application Publication
(10) Pub. No.: US 2024/0276067 A1
(43) Pub. Date: Aug. 15, 2024

(54) INFORMATION PROCESSING METHOD AND APPARATUS, DEVICE, MEDIUM, AND PRODUCT

(71) Applicant: Lemon Inc., Grand Cayman (KY)

(72) Inventors: Gang YAN, Beijing (CN); Xudong MAO, Beijing (CN); Lexin TANG, Los Angeles, CA (US)

(21) Appl. No.: 18/568,734

(22) PCT Filed: Oct. 10, 2022
(86) PCT No.: PCT/SG2022/050721

§ 371 Date: Dec. 8, 2023

(30) Foreign Application Priority Data
Nov. 3, 2021 (CN) 202111295333.8

(51) Int. Cl. H04N 21/488; G06V 20/40; H04N 21/4725

(52) U.S. Cl. CPC H04N 21/4882; G06V 20/46; H04N 21/4725

(57) ABSTRACT

Embodiments of the invention provides an information processing method and apparatus, a device, a medium and a product. The method comprises: determining a key frame in a target video corresponding to a player; obtaining target prompt information of a prompt object in the key frame; based on a playing area of the player, determining an information prompt area of the prompt object; and when the player plays the target video to the key frame, displaying the target prompt information in the information prompt area. Thus, the problem of a player only having one function is solved.

### CROSS-REFERENCE TO RELATED APPLICATION(S)

This application claims priority to Chinese Application No. 202111295333.8, filed in Nov. 3, 2021, and entitled “Information Processing Method and Apparatus, Device, Medium, and Product”, the disclosure of which is incorporated herein by reference in its entity.

### FIELD

Embodiments of the present disclosure relate to the technical field of computers, and in particular, to an information processing method and apparatus, a device, a medium, and a product.

### BACKGROUND

A player is usually used for solving a playing problem, and may mainly include four modules, which are respectively a data receiving module, a data parsing module, a data decoding module and a data output module. The data receiving module may be configured to obtain a data source. The data parsing module may use a parser to separate different types of data, for example, separate a video from an audio. The data decoding module may decode video data or audio data or the like, so as to facilitate the playing. The data output module outputs the data of the decoding technology, and may usually output a video picture by means of a display screen, and output sound by means of a sound card. However, existing players are usually only used for playing videos, so that the playing effectiveness is not high.

### SUMMARY

Embodiments of the present disclosure provide an information processing method and apparatus, a device, a medium, and a product, so as to overcome the problem that an existing player is only used for playing videos, resulting in low playing effectiveness.

In a first aspect, an embodiment of the present disclosure provides an information processing method, including:
determining a key frame in a target video corresponding to a player;
acquiring target prompt information of a prompt object in the key frame;
determining an information prompt area of the prompt object based on a playing area of the player; and
when the player plays the target video to the key frame, displaying the target prompt information in the information prompt area.

In a second aspect, an embodiment of the present disclosure provides an information processing unit, including:
a first determining unit, configured to determine a key frame in a target video corresponding to a player;
an information acquiring unit, configured to acquire target prompt information of a prompt object in the key frame;
a second determining unit, configured to determine an information prompt area of the prompt object based on a playing area of the player; and
an information displaying unit, configured to: when the player plays the target video to the key frame, display the target prompt information in the information prompt area.

In a third aspect, an embodiment of the present disclosure provides an electronic device, including: a processor and a memory;
the memory stores a computer execution instruction; and
the processor executes the computer execution instruction stored in the memory, so that the at least one processor executes the information processing method based on an information flow according to the first aspect and various possible designs of the first aspect.

In a fourth aspect, an embodiment of the present disclosure provides a computer-readable storage medium, wherein a computer execution instruction is stored in the computer-readable storage medium, and when executing the computer execution instruction, a processor implements the information processing method based on an information flow according to the first aspect and various possible designs of the first aspect.

In a fifth aspect, an embodiment of the present disclosure provides a computer program product, including a computer program, wherein when executed by a processor, the computer program implements the information processing method based on an information flow according to the first aspect and various possible designs of the first aspect.

In a sixth aspect, an embodiment of the present disclosure provides a computer program, including a program instruction, wherein when executed by a computer, the program instruction implements the information processing method based on an information flow according to the first aspect and various possible designs of the first aspect.

According to the information processing method provided in the present embodiment, the key frame in the target video corresponding to the player may be determined to acquire the target prompt information of the prompt object in the key frame. Therefore, the information prompt area of the prompt object can be determined based on the playing area of the player, and when the player plays the target video to the key frame, the target prompt information is displayed in the information prompt area. By means of setting the information prompt area in the player, information prompt of the prompt object is realized, a prompt function is added to the player, and thus the information output efficiency of the player is improved.

### BRIEF DESCRIPTION OF THE DRAWINGS

To illustrate technical solutions in the embodiments of the present disclosure or in the prior art more clearly, a brief introduction on the drawings which are needed in the description of the embodiments or the prior art is given below. Apparently, the drawings in the description below are merely some of the embodiments of the present disclosure, based on which other drawings may be obtained by those ordinary skilled in the art without any creative effort.

FIG. 1 is a diagram of an application network architecture of a video-based information processing method provided according to the present disclosure;

FIG. 2 is a flowchart of one embodiment of an information processing method provided in an embodiment of the present disclosure;

FIG. 3 is a flowchart of another embodiment of an information processing method provided in an embodiment of the present disclosure;

FIG. 4 is a schematic diagram of an interface of a player provided in an embodiment of the present disclosure;

FIG. 5 is a flowchart of another embodiment of an information processing method provided in an embodiment of the present disclosure;

FIG. 6 is a schematic diagram of an interface of another player provided in an embodiment of the present disclosure;

FIG. 7 is a structural example diagram of an embodiment of an information processing unit provided in an embodiment of the present disclosure; and

FIG. 8 is a schematic diagram of a hardware structure of an electronic device provided in an embodiment of the present disclosure.

### DETAILED DESCRIPTION OF EMBODIMENTS

In order to make the objectives, technical solutions and advantages of the embodiments of the present disclosure clearer, a clear and complete description of the technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, fall into the protection scope of the present disclosure.

The technical solutions of the present disclosure may be applied to scenarios such as video playing and live streaming, by means of adding an information prompt area to a player, an object prompt function of the player is realized, display multiplexing of the player is realized, and thus the playing effect of the player is improved.

In the related art, a video website platform or a live streaming platform may play a video by means of the player. Taking the live streaming platform as an example, the user terminal of a live streaming user may transmit a collected video to a video server. The user terminal of an audience user with live streaming viewing requirements may request to acquire a live video from the video server. After being processed by a data receiving module, a data parsing module, a data decoding module and a data output module of the player, the live video may be played by the player. However, in this case, the player only has a playing function, such that the player only has a video playing function, accordingly, the function is relatively single, and the usability of the player is not high.

In order to solve the above technical problems, in the technical solutions of the present disclosure, a prompt object in a key frame is obtained by means of analyzing a target video played in the player, and information prompt is performed for the prompt object, so as to implement information display of the prompt object, thereby expanding the display function of the player, and improving the use performance of the player.

In the embodiments of the present disclosure, a key frame in a target video corresponding to a player may be determined to acquire target prompt information of a prompt object in the key frame. Therefore, an information prompt area of the prompt object can be determined based on a playing area of the player, and when the player plays the target video to the key frame, target prompt information is displayed in the information prompt area. By means of setting the information prompt area in the player, information prompt of the prompt object is realized, a prompt function is added to the player, and thus the information output efficiency of the player is improved.

The technical solutions of the present disclosure and how the technical solutions of the present disclosure solve the above technical problems will be described in detail below with specific embodiments. The following several specific embodiments may be combined with each other, and the same or similar concepts or processes may not be repeated in some embodiments. The embodiments of the present disclosure will be described in detail below in combination with the drawings.

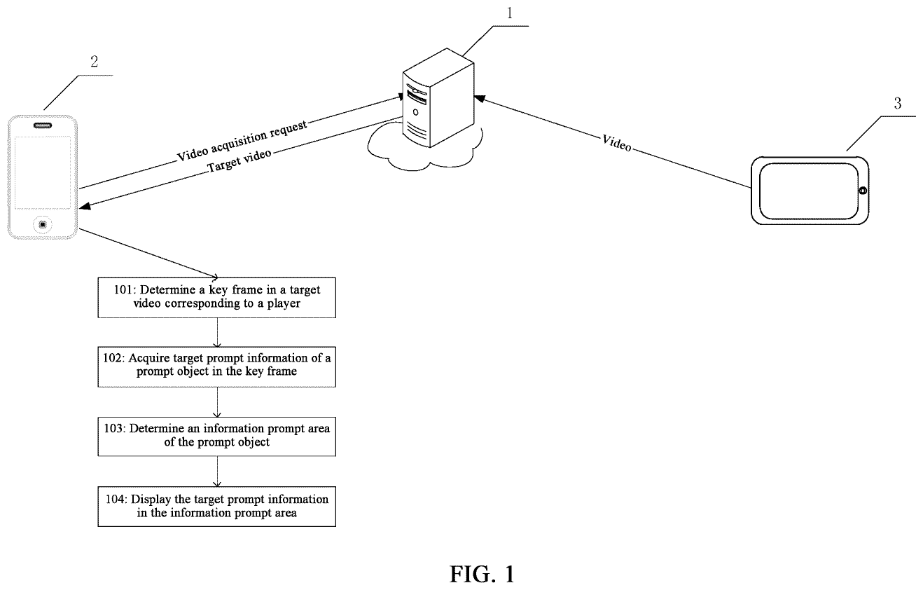

FIG. 1 is a diagram of an application network architecture of an information processing method based on an information flow according to the present disclosure. The application network architecture according to the embodiment of the present disclosure may include an electronic device, and a first client and a second client, which perform a network connection with the electronic device by means of a local area network or a wide area network. It is assumed that the electronic device may be a personal computer, a common server, a super personal computer, a cloud server and other types of servers, and the specific type of the electronic device is not excessively limited in the present disclosure. For example, the first client or the second client may be a terminal device such as a mobile phone, a tablet computer, a personal computer, a smart home appliance, a wearable device, and the like, and the specific type of the client is not excessively limited in the present disclosure.

As shown in FIG. 1, it is taken as an example that the electronic device is a cloud server 1, the first client is a mobile phone 2, and the second client is a tablet computer 3. The second client 3 may send a video to the cloud server 1 and store the video. The first client 2 may request to acquire the video from the cloud server 1, and play the video via a player. During the process of the first client 2 playing the video by using the player, a key frame in a target video corresponding to the player may be determined 101; an information prompt area of a prompt object in the key frame is acquired 102; then, an information prompt area of the prompt object is determined 103; and the target prompt information is displayed in the information prompt area 104. That is, an information prompt function is added to the player by using the information processing method provided in the embodiment of the present disclosure, thereby improving the use efficiency of the player.

For ease of understanding, the technical solutions of the present disclosure will be described in detail below in combination with the drawings.

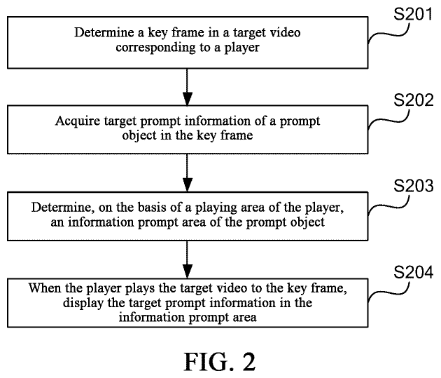

As shown in FIG. 2, it is a flowchart of one embodiment of an information processing method provided in an embodiment of the present disclosure, the method may be applied to an information processing unit, and the information processing unit may be located in a first user terminal. A first user may use the first user terminal to view a video. The information processing method may include the following several steps:

S201: determining a key frame in a target video corresponding to a player.

The technical solutions of the present disclosure may be applied to different application scenarios, for example, a common video playing scenario and a video live streaming scenario. The target video may be, for example, a documentary, a science and educational film, a network course, a live video, a product introduction video, and the like.

When the first user uses the first user terminal to view the target video, the first user terminal may use the player to play the target video for the first user.

The target video may be a video which is pre-loaded by the player and waits to be played, or may be a video which is being played by the player.

The key frame may be an image frame meeting a prompt condition in the target video. In practical applications, there may be at least one key frame.

Determining the key frame in the target video corresponding to the player may include: determining that the target video corresponding to the player contains the key frame of a prompt object.

S202: acquiring target prompt information of the prompt object in the key frame.

The target prompt information of the prompt object may include an object name of the prompt object, object introduction information, transaction link information, object image information, and/or association object information of an association object associated with the prompt object, etc. The association object of the prompt object may be obtained by searching according to the prompt object, and specific reference may be made to a query method of recommended content in a content recommendation scenario in the related art.

The target prompt information may be obtained by searching according to the prompt object, and may also be preset in advance for the prompt object, so as to prompt the information associated with the prompt object.

In practical applications, there may be one or more prompt objects. Each prompt object may correspond to corresponding target prompt information.

S203: determining an information prompt area of the prompt object based on a playing area of the player.

The playing area of the player may be determined according to the display mode of the player and the size of the display screen of the electronic device, and the display mode may include, for example, a normal display mode, a webpage full-screen mode, a common full-screen mode, and the like. Generally, the playing area of the player may be the size of a video screen when the player plays the video.

The information prompt area may be a partial region in the playing area of the player, the position and the proportion of the information prompt area in the playing area of the player do not change, and when the width or height of the playing area of the player changes, the width or height of the information prompt area changes accordingly.

When there are a plurality of prompt objects, each prompt object corresponds to an information prompt area, the information prompt areas of all objects are combined to form an entire comprehensive prompt area, each information prompt area may be a prompt sub-region in the comprehensive prompt area, the prompt sequence of the information prompt area of each prompt object may be randomly determined, may be specified by the user, and may also be determined according to an object-level sequence of the prompt objects, and the arrangement mode of the plurality of information prompt areas is not excessively limited in the present embodiment. The shapes and areas of various information prompt areas of the plurality of prompt objects may be different.

S204: when the player plays the target video to the key frame, displaying the target prompt information in the information prompt area.

The player may play the target video. The video is actually composed of a plurality of image frames, and when the player plays to the key frame, the target prompt information may be displayed in the information prompt area in the playing area of the player.

Optionally, when the player plays the target video to the key frame, displaying the target prompt information in the information prompt area, may include: when the player plays the target video to the key frame, displaying the target prompt information in the information prompt area above the target video.

The video is played in all playing areas of the player, a new display layer is disposed on the upper layer of the video, the size of the display layer may be the information prompt area, and the target prompt information may be displayed in the information prompt area.

When there are a plurality of prompt objects, when the player plays the target video to the key frame, displaying the target prompt information in the information prompt area, may include: when the player plays the target video to the key frame, sequentially displaying the target prompt information of the prompt object in the information prompt area of each prompt object. The information prompt areas of the plurality of prompt objects may be located in a comprehensive prompt area, and each information prompt area may be a sub-region of the comprehensive prompt area. When there is one prompt object, the comprehensive prompt area is the information prompt area of the prompt object.

According to the information processing method provided in the present embodiment, the key frame in the target video corresponding to the player may be determined to acquire the target prompt information of the prompt object in the key frame. Therefore, the information prompt area of the prompt object can be determined based on the playing area of the player, and when the player plays the target video to the key frame, the target prompt information is displayed in the information prompt area. By means of setting the information prompt area in the player, information prompt of the prompt object is realized, a prompt function is added to the player, and thus the information output efficiency of the player is improved.

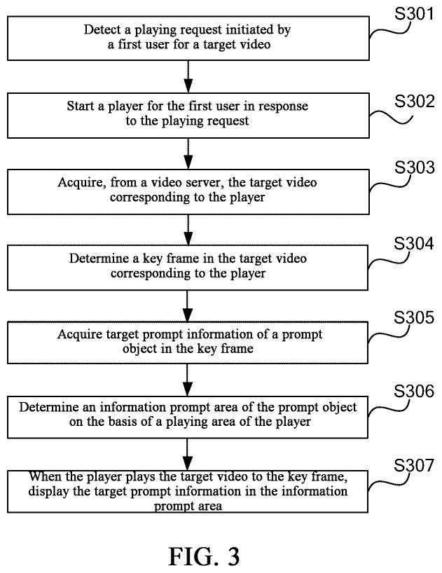

As shown in FIG. 3, it is a flowchart of another embodiment of an information processing method provided in an embodiment of the present disclosure, and the method may include the following several steps:

S301: detecting a playing request initiated by a first user for a target video.

S302: starting a player for the first user in response to the playing request.

S303: acquiring, from a video server, the target video corresponding to the player.

The target video is uploaded to the video server by a second user terminal of a second user.

Some steps in the embodiment of the present disclosure are the same as some steps in the embodiment shown in FIG. 2, and thus are not described herein again for indirect consideration of description.

Optionally, the first client may provide a video viewing function for the first user, for example, the first client may provide a plurality of candidate videos, the first user may select a target video to be viewed from the from the plurality of candidate videos, and trigger the playing request of the target video, and the first client may detect the playing request of the target video.

The target video may be uploaded to the video server by the second user terminal. A plurality of candidate videos may be stored in the video server, and the plurality of candidate videos may be played by any client.

Optionally, the playing request may include video link information of the target video, acquiring, from the video server, and the target video corresponding to the player, may include: according to the video link information in the playing request, acquiring, from the video server, the target video corresponding to the player. The video link information may be, for example, URL (Uniform Resource Locator) information of a playing webpage where the target video is located. The playing webpage may include the player. The video link information may also be, for example, a video storage address of the target video, and acquiring, from the video server, the target video corresponding to the player, may include: acquiring, from the video server, a video corresponding to the video storage address, and determining that the video is the target video corresponding to the player.

S304: determining a key frame in the target video corresponding to the player.

S305: acquiring target prompt information of a prompt object in the key frame.

S306: determining an information prompt area of the prompt object based on a playing area of the player.

S307: when the player plays the target video to the key frame, displaying the target prompt information in the information prompt area.

In the embodiment of the present disclosure, the first user terminal may detect the playing request initiated by the first user for the target video, and start the player for the first user in response to the playing request. Therefore, the target video corresponding to the player is acquired from the video server, such that the target video corresponding to the player is acquired. The target video may be uploaded to the video server by the second user terminal of the second user, so as to be acquired by the first user terminal. After the target video is acquired, the key frame in the target video corresponding to the player may be determined to acquire the target prompt information of the prompt object in the key frame, so as to determine the information prompt area of the prompt object based on the playing area of the player, therefore when the player plays the target video to the key frame, the target prompt information may displayed in the information prompt area. The first user performs playing interaction by using the first user terminal, the target prompt information displayed in the information prompt area may also be viewed based on playing the target video by means of the player, therefore a prompt function is added to the player, prompt information associated with the content of the viewed target video is acquired, the acquisition amount of the information is increased, the content output efficiency of the player is improved, and the functions of the player are effectively expanded.

The target prompt information may be obtained by searching according to the prompt object.

As one embodiment, acquiring the target prompt information of the prompt object in the key frame may include:
identifying the prompt object in the key frame; and
acquiring the target prompt information preset by the second user for the prompt object, wherein the target prompt information is provided when the second user uploads the target video by means of the second user terminal.

Identifying the prompt object in the key frame may include: identifying the prompt object from the key frame by means of a target detection algorithm. The target detection algorithm may be a target detection algorithm based on a neural network, or the like, and the specific type of the target detection algorithm is not excessively limited in the embodiment of the present disclosure.

Optionally, after the prompt object in the key frame is identified, information such as an object name, an object identifier and an object feature of the prompt object may be determined to identify different prompt objects, therefore acquiring the target prompt information preset by the second user for the prompt object may include: searching form, from a plurality of candidate objects preset by the second user, a target object matching the prompt object, so as to acquire, as the target prompt information, object prompt information associated with the target object. Each candidate object may be associated with corresponding target prompt information. The target object matching the prompt object may be a target object having the same object name, the same object identifier and/or the same object feature as the prompt object.

In another possible design, the target prompt information may be named by the object name or the object identifier of the prompt object, so as to identify the prompt object, determine the object name or the object identifier of the prompt object, and query, according to the object name or the object identifier of the prompt object, the target prompt information having the same information name.

Optionally, the target prompt information may be provided when the second user uploads the target video by means of the second user terminal. The video server may store the target video uploaded by the second user terminal, and the target prompt information.

Taking the live streaming scenario as an example, the first user terminal may be an audience terminal, and the second user terminal may be a live streamer terminal. When a live streamer is in live streaming, the live streamer terminal may collect a live video of the live streamer, send the live video to the video server, and meanwhile may send, to the video server together with the live video, the product prompt information of a product, such as a product name, a production place, detailed introduction information, a use effect, a product picture and other information as product prompt information. The audience terminal may request to acquire, from the video server and as the target prompt information, the live video and the product prompt information of the product when the product is used as the prompt object, and the live video and the product prompt information are output at the same time according to the technical solutions of the present disclosure.

In the embodiment of the present disclosure, when acquiring the target prompt information of the prompt object in the key frame, the second user may directly set the prompt object and provide the target prompt information of the prompt object, so that personalized setting of the prompt object by the second user is realized, accordingly, the setting of the prompt object is more accurate, and the prompt accuracy and reliability are improved.

In one possible design, after determining the key frame in the target video corresponding to the player, the method may further include:
determining an interaction displaying area based on the position of the information prompt area in the playing area of the player; and
acquiring interaction information corresponding to the interaction displaying area,
wherein the interaction information is obtained by the input of the first user in the interaction displaying area of the first user terminal and/or by the input of the second user in the second user terminal for the interaction displaying area.

Optionally, the first user terminal may detect the interaction information input by the first user in the interaction displaying area.

The interaction displaying area may be an interaction region in the first user terminal. In order to enable the second user to view the interaction information, the second user terminal may set, in a playing interface, an interaction region matching the interaction displaying area of the first user terminal, so that the interaction information input by the second user in the second user terminal for the interaction displaying area is obtained by the input of the second user in the second user terminal for the interaction region matching the interaction displaying area of the first user terminal.

When the player plays the target video to the key frame, displaying the target prompt information in the information prompt area, may include:
when the player plays the target video to the key frame, displaying the target prompt information in the information prompt area, and displaying the interaction information in the interaction displaying area.

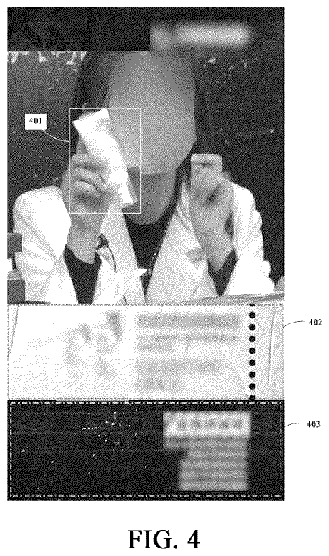

The information prompt area and the interaction displaying area may be displayed in real time. The target prompt information displayed in the information prompt area and the interaction information displayed in the interaction displaying area may be located on the upper layer of the video played by the player, so as to normally play an information video without affecting the playing of the video. For ease of understanding, as shown in FIG. 4, it is a schematic diagram of the playing interface of a player, the playing interface is a video interface in a live streaming scenario, wherein the prompt object is identified in an object prompt area 401, and an information prompt area 402 and an interaction displaying area 403 are disposed directly below the playing area of the player. The target prompt information is displayed in the information prompt area 402, and the interaction information is displayed in the interaction displaying area 403.

In the embodiment of the present disclosure, in addition to displaying the target prompt information, the interaction information may also be displayed in the player. According to the position of the information prompt area in the playing area of the player, the interaction displaying area is determined to acquire the interaction information corresponding to the interaction displaying area, and the interaction information may be obtained by the input of the first user in the interaction displaying area of the first user terminal and/or by the input in the second user terminal for the interaction displaying area. When the player plays the target video to the key frame, the target prompt information may be displayed in the information prompt area, and the interaction information may be displayed in the interaction displaying area, so that simultaneous display of the target prompt information and the interaction information is realized, the display content is further expanded, and the display efficiency of the information is improved.

The prompt object may be an object capable of performing information prompt, for example, may be an article, a person, a plant, a building, a vehicle and other objects in an image, and the specific type of the prompt object is not excessively limited in the embodiment of the present disclosure.

As one possible implementation, acquiring the target prompt information of the prompt object in the key frame may include:
identifying the prompt object in the key frame;
searching, from a plurality of candidate objects of an object database, for a target object matching the prompt object, wherein the plurality of candidate objects respectively correspond to object prompt information; and
determining the object prompt information of the target object to be the target prompt information of the prompt object.

Some steps in the present embodiment are the same as some steps in the foregoing embodiments, and thus are not described herein again for indirect consideration of description.

The object database may be located in a local server and may also be located in a cloud server, and the object database may be pre-established. The plurality of candidate objects may include, for example, a product object, a person object, a plant object, a building object, and the like.

In the embodiment of the present disclosure, when the target prompt information is acquired, the prompt object in the key frame may be identified, so as to search for, from the plurality of candidate objects of the object database, the target object matching the prompt object. By means of setting the object database, automatic query of the object prompt information is realized, so that the acquisition efficiency of the information is improved.

As another possible implementation, acquiring the target prompt information of the prompt object in the key frame may include:
sending the key frame to a server, so that the server extracts object information of the prompt object in the key frame, and searches for the target prompt information matching the object information; and receiving the target prompt information sent by the server.

In the embodiment of the present disclosure, when the target prompt information of the prompt object in the key frame is acquired, the key frame may be sent to the server, the server acquires the object information of the prompt object in the key frame, and searches for the target prompt information matching the object information, therefore intelligent query of the information is realized, and the query efficiency of the information is improved.

In order to obtain an accurate information prompt area, the information prompt area of the prompt object may be set according to a predetermined shape and size. As one embodiment, determining the information prompt area of the prompt object based on the playing area of the player includes:
determining the information prompt area of the prompt object at a predetermined position of the playing area of the player according to the predetermined shape and size.

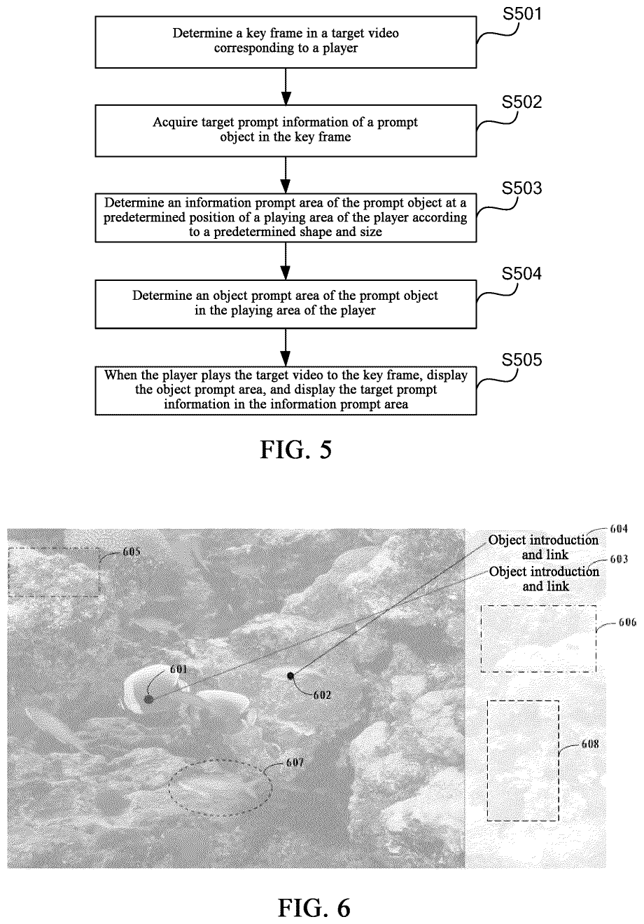

As shown in FIG. 5, it is a flowchart of another embodiment of an information processing method provided in an embodiment of the present disclosure, the method may include the following several steps:

S501: determining a key frame in a target video corresponding to a player.

S502: acquiring target prompt information of a prompt object in the key frame.

S503: determining an information prompt area of the prompt object at a predetermined position of a playing area of the player according to a predetermined shape and size.

S504: determining an object prompt area of the prompt object in the playing area of the player.

S505: when the player plays the target video to the key frame, displaying the object prompt area, and displaying the target prompt information in the information prompt area.

In the embodiment of the present disclosure, in addition to disposing the information prompt area in the playing area of the player, the object prompt area may also be disposed to prompt the prompt object. Therefore, when the player plays the target video to the key frame, the object prompt area is displayed, and the target prompt information is displayed in the information prompt area, so that simultaneous display of the prompt object and the target prompt information is realized, the prompt effect of the target prompt information is clearer, and the prompt efficiency is improved.

As one possible implementation, when the player plays the target video to the key frame, displaying the object prompt area, and displaying the target prompt information in the information prompt area, may include:
when the player plays the target video to the key frame, rendering the target prompt information in the information prompt area; and
displaying the information prompt area where the target prompt information is rendered, and the object prompt area of the prompt object.

In the embodiment of the present disclosure, when the object prompt area and the target prompt information of the object prompt area are displayed, the target prompt information may be first rendered in the information prompt area, then the information prompt information region where the target prompt information is rendered is displayed, and meanwhile, the object prompt information of the prompt object is displayed. Therefore, effective display of the target prompt information and the object prompt information is realized, and the display efficiency is improved.

As one possible implementation, displaying the information prompt area where the target prompt information is rendered, and the object prompt area of the prompt object may include:
generating a prompt line segment by using any point in the object prompt area of the prompt object as a first end point, and using, as a second end point, any point in the information prompt area where the target prompt information is rendered; and
displaying the information prompt area where the target prompt information is rendered, the object prompt area of the prompt object, and the prompt line segment.

In the embodiment of the present disclosure, when the information prompt area where the target prompt information is rendered and the object prompt area of the prompt object are displayed, the prompt line segment may be generated by using any point in the object prompt area of the prompt object as the first end point, and using, as the second end point, any point in the information prompt area where the target prompt information is rendered. Therefore, the information prompt area of the target prompt information, the object prompt area of the prompt object and the prompt line segment are displayed at the same time. The prompt line segment may connect with the information prompt area with the object prompt area, so that the associated display effectiveness of the information prompt area and the object prompt area is higher, and the display efficiency is improved.

Optionally, both ends of the prompt line segment may be respectively any point on the object prompt area and any point on the information prompt area of the target prompt information. Certainly, the object prompt area may include an object position point, and at this time, a point on the object prompt area is the object position point.

Optionally, there may be a plurality of prompt objects, and the object prompt area of each prompt object and the information prompt area of the target prompt information corresponding thereto may be correspondingly displayed. The object position point of each prompt object may be connected with any point in the information prompt area of the target prompt information corresponding thereto, so as to form the prompt line segment. For ease of understanding, as shown in FIG. 6, it is a playing interface of a player, two object prompt areas are shown in the interface as object position points, which are respectively an object position point 601 and an object position point 602, the object position point 601 may generate a prompt line segment with any point in an information prompt area 603 of the target prompt information of the prompt object corresponding thereto, and display the prompt line segment; and the object position point 602 may generate a prompt line segment with any point in an information prompt area 604 of the target prompt information of the prompt object corresponding thereto.

In addition, FIG. 6 further illustrates other prompt areas, including an object prompt area 605, and an information prompt area 606 where the target prompt information corresponding to the prompt object of the object prompt area 605 is located, as well as an object prompt area 607, and an information prompt area 608 where the target prompt information corresponding to the prompt object of the object prompt area 607 is located.

Determining the information prompt area of the prompt object at the predetermined position of the playing area of the player according to the predetermined shape and size may include:
determining the predetermined position according to a central point of the object prompt area of the prompt object; and
determining the information prompt area of the prompt object at the predetermined position and in the upper, lower, left or right direction of the object prompt area according to the predetermined shape and size.

In practical applications, the object prompt area may include: an object boundary box and an object position point. The object prompt area in FIG. 4 is the object boundary box. In some applications, the object prompt area may also display the prompt area of the prompt object in the form of a position point.

Determining the predetermined position according to the central point of the object prompt area of the prompt object may include: determining the predetermined position according to the central point of the object prompt area of the prompt object and based on the length or width of a preset normal video display region, as well as a preset display length or a preset display width. For example, vertical coordinates of the central point of the object prompt area are added with the width of the video play region and a half of width of the object prompt area to obtain the vertical coordinates of the predetermined position, meanwhile, horizontal coordinates of the central point of the object prompt area are used as the horizontal coordinates of the predetermined position, so as to obtain the horizontal and coordinates of the predetermined position, therefore the predetermined position is determined. The information prompt area of the prompt object is disposed below the central point of the object prompt area.

At the same time, in practical applications, the information prompt area may be located above, below, left, or right of the object prompt area. The information prompt area 402 shown in FIG. 4 is located below the object prompt area 401.

The shape of the object prompt area may be any one of shapes such as a rectangle, a circle, an ellipse and a polygon, and the shape of the object prompt area is not excessively limited in the embodiment of the present disclosure.

In the embodiment of the present disclosure, by means of the predetermined position and the direction, for example, the upper, lower, left or right direction of the object prompt area, the accurate setting of the information prompt area may be realized, so that the display association degree between the object prompt area and the information prompt area is higher.

In one possible design, when the player plays the target video to the key frame, displaying the object prompt area, and displaying the target prompt information in the information prompt area, may include:
when the player plays the target video to the key frame, displaying, in the same color, the object prompt area and the target prompt information in the information prompt area.

In practical applications, the object prompt area may include an object prompt box or an object position point, and the information prompt area may include an information prompt box. The transparency of the object prompt box may be 100%, so that normal viewing of the video is not affected when the object prompt box is displayed, the transparency of the information prompt box may be set, and the transparency of the target prompt information may be set to be 0, so as to clearly display the target prompt information. For example, as shown in FIG. 6, the transparency of a comprehensive prompt area where a plurality of information prompt areas are located may be set to be 50%, the transparency of each piece of target prompt information may be set to be 0, that is, not transparent, so as to fuzzily display the played target video while clearly displaying the target prompt information.

In the embodiment of the present disclosure, when the player plays the target video to the key frame, the object prompt area and the target prompt information in the information prompt area may be displayed in the same color, so that the corresponding display effect of the object prompt area and the information prompt area can be more effectively improved, and the display efficiency is improved.

The prompt object may be acquired in a plurality of manners, for example, the prompt object may be automatically identified by an artificial intelligence model and may also be preset by the user.

As one possible implementation, before determining the key frame in the target video corresponding to the player, the method may further include:
acquiring the prompt object set by a third user for the target video; and
determining the key frame in the target video corresponding to the player includes:
determining a plurality of image frames in the target video corresponding to the player; and
identifying, from the plurality of image frames, the key frame containing the prompt object.

In the embodiment of the present disclosure, the prompt object set by the third user for the target video may be acquired, and after the plurality of image frames in the target video corresponding to the player are determined, the key frame containing the prompt object may be identified from the plurality of image frames, thereby enabling the third user to specify the prompt object in the target video, obtaining an accurate prompt effect, and improving the prompt efficiency.

As another possible implementation, determining the key frame in the target video corresponding to the player may include:
extracting, from the target video corresponding to the player and as the key frame, an image frame where an object with an occurrence duration exceeding a predetermined time threshold value is located; and
the method may further include:
determining the object with the occurrence duration exceeding the predetermined time threshold value to be the prompt object.

In the embodiment of the present disclosure, the image frame where the object with the occurrence duration exceeding the predetermined time threshold value is located may be extracted from the target video corresponding to the player as the key frame, and then the object with the occurrence duration exceeding the predetermined time threshold value is determined to be the prompt object, therefore automatic detection of the prompt object is realized. By means of the automatic detection of the prompt object and the display of the target prompt information, the information prompt of the prompt object is implemented with high efficiency and high accuracy.

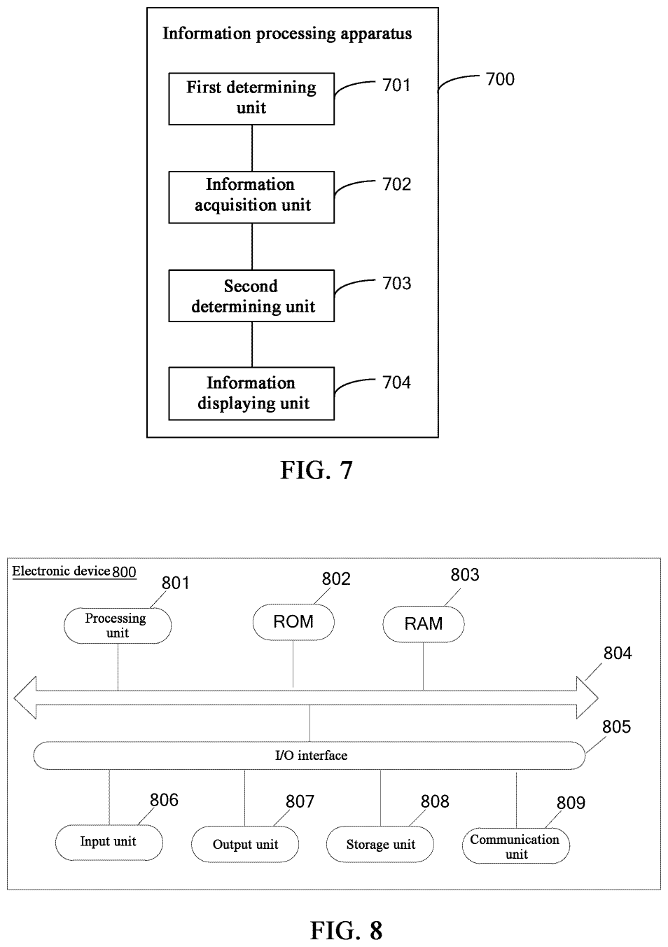

As shown in FIG. 7, it is a structural example diagram of an embodiment of an information processing unit provided in an embodiment of the present disclosure, wherein the information processing unit 700 may include the following several units:
a first determining unit 701, configured to determine a key frame in a target video corresponding to a player;
an information acquiring unit 702, configured to acquire target prompt information of a prompt object in the key frame;
a second determining unit 703, configured to determine an information prompt area of the prompt object based on a playing area of the player; and
an information displaying unit 704, configured to: when the player plays the target video to the key frame, display the target prompt information in the information prompt area.

According to the information processing method provided in the present embodiment, the key frame in the target video corresponding to the player may be determined to acquire the target prompt information of the prompt object in the key frame. Therefore, the information prompt area of the prompt object can be determined based on the playing area of the player, and when the player plays the target video to the key frame, the target prompt information is displayed in the information prompt area. By means of setting the information prompt area in the player, information prompt of the prompt object is realized, a prompt function is added to the player, and thus the information output efficiency of the player is improved.

As one embodiment, the apparatus may further include:
a request detection unit, configured to detect a playing request initiated by a first user for a target video;
a playback starting unit, configured to start the player for the first user in response to the playing request; and
a video acquisition unit, configured to acquire the target video of the player from a video server, wherein the target video is uploaded to the video server by a second user terminal of a second user.

In one possible design, the information acquiring unit may include:
a first identification module, configured to identify the prompt object in the key frame; and
a first acquisition module, configured to acquire the target prompt information preset by the second user for the prompt object, wherein the target prompt information is provided when the second user uploads the target video by means of the second user terminal.

As another embodiment, the apparatus may further include:
a region determining unit, configured to determine an interaction displaying area based on the position of the information prompt area in the playing area of the player; and
an interaction acquisition unit, configured to acquire interaction information corresponding to the interaction displaying area, wherein the interaction information is obtained by the input of the first user in the interaction displaying area of the first user terminal and/or by the input of the second user in the second user terminal for the interaction displaying area; and
the Information displaying unit may include:
a first display module, configured to: when the player plays the target video to the key frame, display the target prompt information in the information prompt area, and display the interaction information in the interaction displaying area.

In one possible design, the information acquiring unit may include:
a second identification module, configured to identify the prompt object in the key frame;
an object search module, configured to search for, from a plurality of candidate objects of an object database, a target object matching the prompt object, wherein the plurality of candidate objects respectively correspond to object prompt information; and
an information determining module, configured to determine the object prompt information of the target object to be the target prompt information of the prompt object.
   In yet another possible design, the information acquiring unit may include:
a first sending module, configured to send the key frame to a server, so that the server extracts object information of the prompt object in the key frame, and searches for the target prompt information matching the object information; and
an information receiving module, configured to receive the target prompt information sent by the server.

As one embodiment, the second determining unit includes:
a region determining module, configured to determine the information prompt area of the prompt object at a predetermined position of the playing area of the player according to a predetermined shape and size.

In some embodiments, the apparatus further includes:
a third determining unit, configured to determine an object prompt area of the prompt object in the playing area of the player; and
the Information displaying unit includes:
a second display module, configured to: when the player plays the target video to the key frame, display the object prompt area, and display the target prompt information in the information prompt area.

In one possible design, the second display module includes:
an information rendering sub-module, configured to: when the player plays the target video to the key frame, render the target prompt information in the information prompt area; and
an information display sub-module, configured to display the information prompt area where the target prompt information is rendered, and the object prompt area of the prompt object.

In some embodiments, the information display sub-module may be specifically configured to:
generate a prompt line segment by using any point in the object prompt area of the prompt object as a first end point, and using, as a second end point, any point in the information prompt area where the target prompt information is rendered; and
display the information prompt area where the target prompt information is rendered, the object prompt area of the prompt object, and the prompt line segment.

In some embodiments, the information rendering sub-module may be specifically configured to:
determine the predetermined position according to a central point of the object prompt area of the prompt object; and
determine the information prompt area of the prompt object at the predetermined position and in the upper, lower, left or right direction of the object prompt area according to the predetermined shape and size.

As one possible implementation, the first display module may include:
a color display sub-unit, configured to: when the player plays the target video to the key frame, display, in the same color, the object prompt area and the target prompt information in the information prompt area.

As another embodiment, the apparatus further includes:
an object acquisition unit, configured to acquire the prompt object set by a third user for the target video; and
the first determining unit may include:
an image determining module, configured to determine a plurality of image frames in the target video corresponding to the player; and
an image identification module, configured to identify, from the plurality of image frames, the key frame containing the prompt object.

As another embodiment, the first determining unit may include:
an object extraction module, configured to extract, from the target video corresponding to the player and as the key frame, an image frame where an object with an occurrence duration exceeding a predetermined time threshold value is located; and
the apparatus may further include:
an object determining module, configured to determine the object with the occurrence duration exceeding the predetermined time threshold value to be the prompt object.

The apparatus provided in the present embodiment may be used to execute the technical solutions of the foregoing method embodiments, and the implementation principles and technical effects thereof are similar, therefore details are not described in the present embodiment again.

To implement the above embodiments, an embodiment of the present disclosure further provides an electronic device.

Referring to FIG. 8, it illustrates a schematic structural diagram of an electronic device 800 suitable for implementing the embodiments of the present disclosure. The electronic device 800 may be a terminal device or a server. The terminal device may include, but is not limited to, mobile terminals such as mobile phones, notebook computers, digital broadcast receivers, personal digital assistants (PDAs for short), portable Android devices (PADs for short), portable media players (PMPs for short), vehicle-mounted terminals (e.g., vehicle-mounted navigation terminals), and the like, and fixed terminals such as digital TVs, desktop computers, and the like. The electronic device shown in FIG. 8 is merely an example, and should not bring any limitation to the functions and use ranges of the embodiments of the present disclosure.

As shown in FIG. 8, the electronic device 800 may include a processing unit (e.g., a central processing unit, a graphics processing unit, or the like) 801, which may perform various suitable actions and processes in accordance with a program stored in a read only memory (ROM for short) 802 or a program loaded from a storage unit 808 into a random access memory (RAM for short) 803. In the RAM 803, various programs and data needed by the operations of the electronic device 800 are also stored. The processing unit 801, the ROM 802 and the RAM 803 are connected to each other via a bus 804. An input/output (I/O for short) interface 805 is also connected to the bus 804.

In general, the following apparatuses may be connected to the I/O interface 805: an input unit 806, including, for example, a touch screen, a touch pad, a keyboard, a mouse, a camera, a microphone, an accelerometer, a gyroscope, and the like; an output unit 807, including, for example, a liquid crystal display (LCD for short), a speaker, a vibrator, and the like; a storage unit 808, including, for example, a magnetic tape, a hard disk, and the like; and a communication unit 809. The communication unit 809 may allow the electronic device 800 to communicate in a wireless or wired manner with other devices to exchange data. Although FIG. 8 illustrates the electronic device 800 having various apparatuses, it should be understood that not all illustrated apparatuses are required to be implemented or provided. More or fewer apparatuses may alternatively be implemented or provided.

In particular, according to the embodiments of the present disclosure, the processes described above with reference to the flowcharts may be implemented as computer software programs. For example, the embodiments of the present disclosure include a computer program product, which includes a computer program carried on a computer-readable medium, and the computer program contains program codes for performing the method illustrated in the flowcharts. In such embodiments, the computer program may be downloaded and installed from a network via the communication unit 809, or installed from the storage unit 808, or installed from the ROM 802. When the computer program is executed by the processing unit 801, the above functions defined in the method of the embodiments of the present disclosure are performed.

It should be noted that, the computer-readable medium described above in the present disclosure may be either a computer-readable signal medium or a computer-readable storage medium, or any combination of the two. The computer-readable storage medium may be, for example, but is not limited to, an electronic, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory (RAM), a read only memory (ROM), an erasable programmable read only memory (EPROM for short or flash memory), an optical fiber, a portable compact disc read only memory (CD-ROM), an optical storage device, a magnetic storage device, or any suitable combination of the above. In the present disclosure, the computer-readable storage medium may be any tangible medium that contains or stores a program, wherein the program may be used by or in conjunction with an instruction execution system, apparatus or device. In the present disclosure, the computer-readable signal medium may include a data signal that is propagated in a baseband or as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in conjunction with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

The computer-readable medium may be contained in the above electronic device; and it may also be present separately and is not assembled into the electronic device.

The computer-readable medium carries one or more programs that, when executed by the electronic device, cause the electronic device to execute the method shown in the above embodiments.

Computer program codes for executing the operations of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network, including a local area network (LAN for short) or a wide area network (WAN for short), or it may be connected to an external computer (e.g., through the Internet using an Internet service provider).

The flowcharts and region diagrams in the drawings illustrate the system architecture, functions and operations of possible implementations of systems, methods and computer program products according to various embodiments of the present disclosure. In this regard, each square region in the flowcharts or region diagrams may represent a part of a module, a program segment, or a code, which contains one or more executable instructions for implementing specified logical functions. It should also be noted that, in some alternative implementations, the functions annotated in the square region may occur out of the order annotated in the drawings. For example, two square regions shown in succession may, in fact, be executed substantially concurrently, or the square regions may sometimes be executed in a reverse order, depending upon the functions involved. It should also be noted that each square region in the region diagrams and/or flowcharts, and combinations of the square regions in the region diagrams and/or flowcharts may be implemented by dedicated hardware-based systems for performing specified functions or operations, or combinations of dedicated hardware and computer instructions.

The units involved in the described embodiments of the present disclosure may be implemented in a software or hardware manner. The names of the units do not constitute limitations of the units themselves in a certain case. For example, a first acquisition unit may also be described as “a unit for acquiring at least two Internet Protocol addresses”.

The functions described herein above may be performed, at least in part, by one or more hardware logic components. For example, without limitation, example types of the hardware logic components that may be used include: a field programmable gate array (FPGA for short), an application specific integrated circuit (ASIC for short), an application specific standard product (ASSP for short), a system on chip (SOC for short), a complex programmable logic device (CPLD for short), and so on.

In the context of the present disclosure, a machine-readable medium may be a tangible medium, which may contain or store a program for use by or in conjunction with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read only memory (ROM), an erasable programmable read only memory (EPROM or a flash memory), an optical fiber, a compact disc read only memory (CD-ROM), an optical storage device, a magnetic storage device, or any suitable combination thereof.

In a first aspect, according to one or more embodiments of the present disclosure, provided is an information processing method, including:
determining a key frame in a target video corresponding to a player;
acquiring target prompt information of a prompt object in the key frame;
determining an information prompt area of the prompt object based on a playing area of the player; and
when the player plays the target video to the key frame, displaying the target prompt information in the information prompt area.

According to one or more embodiments of the present disclosure, the method further includes:
detecting a playing request initiated by a first user for the target video;
starting the player for the first user in response to the playing request; and
acquiring, from a video server, the target video corresponding to the player, wherein the target video is uploaded to the video server by a second user terminal of a second user.

Acquiring the target prompt information of the prompt object in the key frame includes:
identifying the prompt object in the key frame; and
acquiring the target prompt information preset by the second user for the prompt object, wherein the target prompt information is provided when the second user uploads the target video by means of the second user terminal.

According to one or more embodiments of the present disclosure, the method further includes:
determining an interaction displaying area based on the position of the information prompt area in the playing area of the player; and
acquiring interaction information corresponding to the interaction displaying area, wherein the interaction information is obtained by the input of the first user in the interaction displaying area of the first user terminal and/or by the input of the second user in the second user terminal for the interaction displaying area; and
when the player plays the target video to the key frame, displaying the target prompt information in the information prompt area, includes:
when the player plays the target video to the key frame, displaying the target prompt information in the information prompt area, and displaying the interaction information in the interaction displaying area.

According to one or more embodiments of the present disclosure, acquiring the target prompt information of the prompt object in the key frame includes:
identifying the prompt object in the key frame;
searching, from a plurality of candidate objects of an object database, for a target object matching the prompt object, wherein the plurality of candidate objects respectively correspond to object prompt information; and
determining the object prompt information of the target object to be the target prompt information of the prompt object.

According to one or more embodiments of the present disclosure, acquiring the target prompt information of the prompt object in the key frame includes:
sending the key frame to a server, so that the server extracts object information of the prompt object in the key frame, and searches for the target prompt information matching the object information; and
receiving the target prompt information sent by the server.

According to one or more embodiments of the present disclosure, determining the information prompt area of the prompt object based on the playing area of the player includes:
determining the information prompt area of the prompt object at a predetermined position of the playing area of the player according to a predetermined shape and size.

According to one or more embodiments of the present disclosure, the method further includes:
determining an object prompt area of the prompt object in the playing area of the player; and
when the player plays the target video to the key frame, displaying the target prompt information in the information prompt area, includes:
when the player plays the target video to the key frame, displaying the object prompt area, and displaying the target prompt information in the information prompt area.

According to one or more embodiments of the present disclosure, when the player plays the target video to the key frame, displaying the object prompt area, and displaying the target prompt information in the information prompt area, includes:
when the player plays the target video to the key frame, rendering the target prompt information in the information prompt area; and
displaying the information prompt area where the target prompt information is rendered, and the object prompt area of the prompt object.

According to one or more embodiments of the present disclosure, displaying the information prompt area where the target prompt information is rendered, and the object prompt area of the prompt object includes:
generating a prompt line segment by using any point in the object prompt area of the prompt object as a first end point, and using, as a second end point, any point in the information prompt area where the target prompt information is rendered; and
displaying the information prompt area where the target prompt information is rendered, the object prompt area of the prompt object, and the prompt line segment.

According to one or more embodiments of the present disclosure, determining the information prompt area of the prompt object at the predetermined position of the playing area of the player according to the predetermined shape and size, may include:
determining the predetermined position according to a central point of the object prompt area of the prompt object; and
determining the information prompt area of the prompt object at the predetermined position and in the upper, lower, left or right direction of the object prompt area according to the predetermined shape and size.

According to one or more embodiments of the present disclosure, when the player plays the target video to the key frame, displaying the object prompt area, and displaying the target prompt information in the information prompt area, includes:
when the player plays the target video to the key frame, displaying, in the same color, the object prompt area and the target prompt information in the information prompt area.

According to one or more embodiments of the present disclosure, the method further includes:
acquiring the prompt object set by a third user for the target video;
determining the key frame in the target video corresponding to the player includes:
determining a plurality of image frames in the target video corresponding to the player; and
identifying, from the plurality of image frames, the key frame containing the prompt object.

According to one or more embodiments of the present disclosure, determining the key frame in the target video corresponding to the player includes:
extracting, from the target video corresponding to the player and as the key frame, an image frame where an object with an occurrence duration exceeding a predetermined time threshold value is located; and
the method further includes:
determining the object with the occurrence duration exceeding the predetermined time threshold value to be the prompt object.

In a second aspect, according to one or more embodiments of the present disclosure, provided is an information processing unit, including:
a first determining unit, configured to determine a key frame in a target video corresponding to a player;
an information acquiring unit, configured to acquire target prompt information of a prompt object in the key frame;
a second determining unit, configured to determine an information prompt area of the prompt object based on a playing area of the player; and
an information displaying unit, configured to: when the player plays the target video to the key frame, display the target prompt information in the information prompt area.

In a third aspect, according to one or more embodiments of the present disclosure, provided is an electronic device, including: at least one processor and a memory;
the memory stores a computer execution instruction; and
the at least one processor executes the computer execution instruction stored in the memory, so that the at least one processor executes the information processing method based on an information flow according to the first aspect and various possible designs of the first aspect.

In a fourth aspect, according to one or more embodiments of the present disclosure, provided is computer-readable storage medium, wherein a computer execution instruction is stored in the computer-readable storage medium, and when executing the computer execution instruction, a processor implements the information processing method based on an information flow according to the first aspect and various possible designs of the first aspect.

In a fifth aspect, according to one or more embodiments of the present disclosure, provided is a computer program product, including a computer program, wherein when executed by a processor, the computer program implements the information processing method based on an information flow according to the first aspect and various possible designs of the first aspect.

In a sixth aspect, an embodiment of the present disclosure provides a computer program, including a program instruction, wherein when executed by a computer, the program instruction implements the information processing method based on an information flow according to the first aspect and various possible designs of the first aspect.

What have been described above are only preferred embodiments of the present disclosure and illustrations of the technical principles employed. It will be appreciated by those skilled in the art that the disclosure scope involved in the present disclosure is not limited to the technical solutions formed by specific combinations of the above technical features, and meanwhile should also include other technical solutions formed by any combinations of the above technical features or equivalent features thereof without departing from the concept of the present disclosure, for example, technical solutions formed by mutual replacement of the above features with technical features having similar functions disclosed in the present disclosure (but is not limited to).

In addition, although various operations are depicted in a particular order, this should not be understood as requiring that these operations are performed in the particular order shown or in a sequential order. In certain circumstances, multitasking and parallel processing may be advantageous. Similarly, although several specific implementation details have been contained in the above discussion, these should not be construed as limiting the scope of the present disclosure. Certain features that are described in the context of separate embodiments may also be implemented in combination in a single embodiment. Conversely, various features that are described in the context of a single embodiment may also be implemented in a plurality of embodiments separately or in any suitable sub-combination.

Although the present subject matter has been described in language specific to structural features and/or methodological actions, it should be understood that the subject matter defined in the appended claims is not necessarily limited to the specific features or actions described above. Rather, the specific features and actions described above are merely example forms of implementing the claims.

What is claimed is:

1. An information processing method, comprising:
determining a key frame in a target video corresponding to a player;
acquiring target prompt information of a prompt object in the key frame;
determining, based on a playing area of the player, an information prompt area of the prompt object; and
when the player plays the target video to the key frame, displaying the target prompt information in the information prompt area.

2. The method according to claim 1, further comprising:
detecting a playing request initiated by a first user for the target video;
starting the player for the first user in response to the playing request; and
acquiring, from a video server, the target video corresponding to the player, wherein the target video is uploaded to the video server by a second user terminal of a second user.

3. The method according to claim 2, wherein acquiring the target prompt information of the prompt object in the key frame comprises:
identifying the prompt object in the key frame; and
acquiring the target prompt information preset by the second user for the prompt object, wherein the target prompt information is provided when the second user uploads the target video by means of the second user terminal.

4. The method according to claim 3, further comprising:
determining an interaction displaying area based on the position of the information prompt area in the playing area of the player; and
acquiring interaction information corresponding to the interaction displaying area, wherein the interaction information is obtained by the input of the first user in the interaction displaying area of the first user terminal and/or by the input of the second user in the second user terminal for the interaction displaying area; and
when the player plays the target video to the key frame, displaying the target prompt information in the information prompt area, comprises:
when the player plays the target video to the key frame, displaying the target prompt information in the information prompt area, and displaying the interaction information in the interaction displaying area.

5. The method according to claim 1, wherein acquiring the target prompt information of the prompt object in the key frame comprises:
identifying the prompt object in the key frame;
searching, from a plurality of candidate objects of an object database, for a target object matching the prompt object, wherein the plurality of candidate objects respectively correspond to object prompt information; and
determining the object prompt information of the target object to be the target prompt information of the prompt object.

6. The method according to claim 1, wherein acquiring the target prompt information of the prompt object in the key frame comprises:
sending the key frame to a server, extracting, by the server, object information of the prompt object in the key frame, and searching for the target prompt information matching the object information; and
receiving the target prompt information sent by the server.

7. The method according to claim 1, wherein determining the information prompt area of the prompt object based on the playing area of the player comprises:
determining the information prompt area of the prompt object at a predetermined position of the playing area of the player according to a predetermined shape and size.

8. The method according to claim 1, further comprising:
determining an object prompt area of the prompt object in the playing area of the player; and
when the player plays the target video to the key frame, displaying the target prompt information in the information prompt area, comprises:
when the player plays the target video to the key frame, displaying the object prompt area, and displaying the target prompt information in the information prompt area.

9. The method according to claim 1, further comprising:
acquiring the prompt object set by a third user for the target video; and
determining the key frame in the target video corresponding to the player comprises:
determining a plurality of image frames in the target video corresponding to the player; and
identifying, from the plurality of image frames, the key frame containing the prompt object.

10. The method according to claim 1, wherein determining the key frame in the target video corresponding to the player comprises:
extracting, from the target video corresponding to the player and as the key frame, an image frame where an object with an occurrence duration exceeding a predetermined time threshold value is located; and
the method further comprises:
determining the object with the occurrence duration exceeding the predetermined time threshold value to be the prompt object.

11. (canceled)

12. An electronic device comprising a processor and a memory, wherein
the memory stores a computer execution instruction; and
the processor executes the computer execution instruction stored in the memory, so that the processor executes acts comprising:
determining a key frame in a target video corresponding to a player;
acquiring target prompt information of a prompt object in the key frame;
determining, based on a playing area of the player, an information prompt area of the prompt object; and
when the player plays the target video to the key frame, displaying the target prompt information in the information prompt area.

13. (canceled)

14. A computer program product, comprising a computer program, wherein the computer program, when executed by a processor, causes the processor to execute acts comprising:
determining a key frame in a target video corresponding to a player;
acquiring target prompt information of a prompt object in the key frame;
determining, based on a playing area of the player, an information prompt area of the prompt object; and
when the player plays the target video to the key frame, displaying the target prompt information in the information prompt area.

15. (canceled)

16. The electronic device according to claim 12, the acts further comprising:
detecting a playing request initiated by a first user for the target video;
starting the player for the first user in response to the playing request; and
acquiring, from a video server, the target video corresponding to the player, wherein the target video is uploaded to the video server by a second user terminal of a second user.

17. The electronic device according to claim 12, wherein acquiring the target prompt information of the prompt object in the key frame comprises:
identifying the prompt object in the key frame;
searching, from a plurality of candidate objects of an object database, for a target object matching the prompt object, wherein the plurality of candidate objects respectively correspond to object prompt information; and
determining the object prompt information of the target object to be the target prompt information of the prompt object.

18. The electronic device according to claim 12, wherein acquiring the target prompt information of the prompt object in the key frame comprises:
sending the key frame to a server, extracting, by the server, object information of the prompt object in the key frame, and searching for the target prompt information matching the object information; and
receiving the target prompt information sent by the server.

19. The electronic device according to claim 12, wherein determining the information prompt area of the prompt object based on the playing area of the player comprises:
determining the information prompt area of the prompt object at a predetermined position of the playing area of the player according to a predetermined shape and size.

20. The computer program product according to claim 14, wherein acquiring the target prompt information of the prompt object in the key frame comprises:
identifying the prompt object in the key frame;
searching, from a plurality of candidate objects of an object database, for a target object matching the prompt object, wherein the plurality of candidate objects respectively correspond to object prompt information; and
determining the object prompt information of the target object to be the target prompt information of the prompt object.

21. The computer program product according to claim 14, wherein acquiring the target prompt information of the prompt object in the key frame comprises:
sending the key frame to a server, extracting, by the server, object information of the prompt object in the key frame, and searching for the target prompt information matching the object information; and
receiving the target prompt information sent by the server.

22. The computer program product according to claim 14, wherein determining the information prompt area of the prompt object based on the playing area of the player comprises:
determining the information prompt area of the prompt object at a predetermined position of the playing area of the player according to a predetermined shape and size.

23. The computer program product according to claim 14, wherein determining the key frame in the target video corresponding to the player comprises:
extracting, from the target video corresponding to the player and as the key frame, an image frame where an object with an occurrence duration exceeding a predetermined time threshold value is located; and
the method further comprises:
determining the object with the occurrence duration exceeding the predetermined time threshold value to be the prompt object.
